(19) United States
(12) Patent Application Publication
(10) Pub. No.: US 2006/0152706 A1
(43) Pub. Date: Jul. 13, 2006

(54) Multi-modal authentication, anti-diversion and asset management and method

(76) Inventor: Charles L. Butland, Playa Del Rey, CA (US)

Correspondence Address: MUELLER AND SMITH, LPA;MUELLER-SMITH BUILDING, 7700 RIVERS EDGE DRIVE, COLUMBUS, OH, 43235, US

(21) Appl. No.: 10/805,010

(22) Filed: Mar. 19, 2004

(51) Int. Cl. G06K 9/74

(52) U.S. Cl. 356/71

(57) ABSTRACT

The present invention employs multi-modalities for authentication, anti-diversion, and asset management (AADAM). The multi-modalities employed in the AADAM system include combinations of Raman spectral analysis; DNA/RNA and other biologic taggants, optionally animal consumable; pit & land marks; algorithmic marks; and spectral analysis with quantum dots (QD's).

### CROSS-REFERENCE TO RELATED APPLICATIONS

None

### STATEMENT REGARDING FEDERALLY SPONSORED RESEARCH

Not applicable.

### BACKGROUND OF THE INVENTION

The present invention relates to the labeling of objects for verifying authenticity and more particularly to the use of multiple selectively perceptible marks for labeling of objects. Authenticity implies both that the goods are genuine and that they are in the proper channels of commerce. If the goods are not genuine, then product counterfeiting has occurred and the present invention presents the ability to determine whether or not goods are genuine. If the goods have been diverted from their intended channel of commerce by, for example, entering into a country where the goods are prohibited, for example, by contract or by law, then the goods have been subject to product diversion. Again, the present invention presents the ability to determine whether genuine goods have been improperly diverted. Finally, the term, “diverted goods”, also comprehends genuine goods, which have been stolen and the identity of the goods is at issue.

Many objects require verification for authentication purposes. Such objects include paintings, sculptures, cartoon cells, sports and other collectibles, and like works of art; videocassette recorders (VCRs), televisions, and like household objects; and computers; printers, and like office and business equipment. Other instances of identification in order to verify ownership, include, for example, records, audio and video tape cassettes, computer software recorded on floppy disks or diskettes, perfumes, designer clothes, handbags, briefcases, cartoon cells, automobile/airplane parts, securities (e.g., stock certificates), wills, identification cards (driver's licenses, passports, visas, green cards), credit cards, smart cards, and like objects.

Another class of goods requiring verification and authentication are comestibles, including both pharmaceuticals and foodstuffs. Counterfeit drugs have plagued underdeveloped countries for years. More than 7% of the world's pharmaceuticals are bogus, according to the World Health Organization. In Colombia, up to 40 percent of medications are believed to be fake. But until recently, a tightly controlled regulatory system has made it extraordinarily difficult for counterfeiters to slip suspect medications into the United States. Now, however, that system is straining under an explosion of Internet drug sales from overseas and increasingly sophisticated counterfeiting techniques.

While, perhaps, not as economically impacting as drugs, foods also can suffer from being out-of-date, from containing ingredients not listed on the label, etc. So too, there is a need to be able to track and verify the genuineness of foodstuffs in general, as well as pharmaceuticals.

A flagrant piracy explosion over the past decade involving many of the foregoing products has plagued many industries. Often, these objects have no serial number or other unique means of identification, or the number can be removed easily following a theft. Alternatively, counterfeiting of such objects has become a thriving business and the need to identify authentic from counterfeit objects is of great importance.

In a related, but different, scenario, genuine goods are limited to being shipped and sold in selected jurisdictions (e.g., countries), for example, by law or by contract. When genuine goods are diverted to countries where their presence is not authorized, then “product diversion” has occurred. Product diversion can lead to, inter alia, price inequities in certain markets as well as loss of exclusivity by some manufacturers or distributors. This situation often is referred to as “gray market” goods. Since the goods are genuine, it is quite difficult to determine whether the goods have been improperly diverted. This is especially true for a variety of goods such as, for example, clothing.

In U.S. Pat. No. 5,599,578, there is disclosed a technique for labeling objects for their identification and/or authentication involving the use of a combination of a mark visible to the naked eye and a mark invisible to the naked eye. The invisible mark or component of the system is one or more of an ultraviolet radiation (UV) dye, an infrared (IR) dye, an ink that displays a selected measurable electrical resistivity, or a biologic marker which may be a protein, amino acid, DNA, polypeptide, hormone, or antibody.

U.S. Pat. No. 6,030,657 is directed to a method for labeling an object for its identification. This method includes providing a biologic marker labeled with an agent that emits selected detectable wavelengths of energy when exposed to infrared radiation (IR), and associating the labeled marker with the object, whereby, the object to be identified can be exposed to IR and emitted select wavelengths of energy from said agent detected. The agent can be an upconverting phosphor, a lanthenide ion (bound to a naphthalene group), or other chemical that emits selected detectable wavelengths of energy when exposed to infrared radiation (IR). The materials are encapsulated in an encapsulant that is resistant to the environment in which the materials are used such as, for example, an ink formulation. However, the encapsulant can be opened (e.g., by selective dissolving) and the materials inside (e.g., biologic, IR emitting, etc.) determined. A presently preferred encapsulant is casein which has been self cross-linked to provide resistance to hydrophobic ink formulations in which it desirably is placed.

### BRIEF SUMMARY OF THE INVENTION

One aspect of the invention is method for labeling an object for one or more of its identification, authentication, or asset management. This method commences with creating on said object an algorithmic mark. Next, one or more of Raman spectral material, a biologic taggant, an optical taggant, or a spectral quantum dot (QD) is associated with said algorithmic mark. Such association is accomplished by one or more of incorporating in said algorithmic mark one or more of Raman spectral material, a biologic taggant, an optical taggant, or a spectral quantum dot (QD); or overcoating said algorithmic mark with a transparent coating containing one or more of Raman spectral material, a biologic taggant, an optical taggant, or a spectral quantum dot (QD).

Another aspect of the invention is a method for labeling an object for one or more of its identification, authentication, or asset management. This method commences with creating on said object a pit and land code. Next, such code is overcoated with a coating containing one or more of Raman spectral material, an optical taggant, or a spectral quantum dot (QD).

Another aspect of the invention is a combination mark wherein both an algorithmic mark and a pit and land code are created on an object. Each of these codes can be associated with taggants, as described above.

### DETAILED DESCRIPTION OF THE INVENTION

The present invention employs multi-modalities for authentication, anti-diversion, and asset management (AADAM). The inventive AADAM system is a matrix of technologies, some proven and some new, that can be selected for use with virtually any product for ensuring that the product is genuine and is in the proper channel of commerce. Thus, the AADAM system employs a combination of field-determinable marks for initial screening of products in their commercial environment coupled with laboratory determinable marks for in depth identification of the goods. The inventive AADAM system can provide a spectrum of information about the product including, inter alia, its date of manufacture, its location of manufacture, its intended distributor, its permitted channels of commerce, etc. There is virtually no piece of information that cannot be encoded by the AADAM system for use in ensuring that the product is genuine and has not been diverted (i.e., is in the proper channel of commerce.

The multi-modalities employed in the MDAM system include combinations of the following:

(1) Raman spectral analysis;

(2) DNA/RNA and other biologic taggants, optionally animal consumable;

(3) pit & land marks;

(4) algorithmic marks; and

(5) spectral analysis with quantum dots (QD's).

As stated above, an advantage of the present invention is the ability to combine new and existing marking technologies into a multi-modal marking system. For example, the coating that overlays the pit & land marks can be further identified by incorporating Raman analysis, biologic taggants, and/or algorithmic marks. Biologic taggants can be marked with one or more of Raman spectral material, optical taggants, or algorithmic identifiers. Algorithmic marks can be laced with one or more of Raman spectral material, biologic taggants, or optical taggants. In fact, the biologic taggants added to the algorithmic marks can themselves be labeled with one or more of Raman spectral material or optical taggants. Quantum dot encapsulating material can be laced with one or more of a biologic marker (optionally tagged) Ramen scattering material, or algorithmic material, and optionally laid down over a pit & land marked system as part of the overcoat and/or in addition to the pit & and overcoat. Encapsulated QD's also could be placed in an ink for creating spectral barcodes and the ink laced with one or more of Raman spectral material, biologic taggants, or algorithmic materials. Thus, it will be seen that a very powerful multi-modal marking system can be constructed.

Raman Scattering

The Raman scattering effect is a process in which light is frequency downshifted in a material. The frequency downshift results from a nonlinear interaction between light and the material. The difference in frequency between the input light and the frequency downshifted light is referred to as the Stokes shift which in silica fibers is of the order 13 THz.

When photons of two different wavelengths are present in an optical fiber, Raman scattering effect can be stimulated. This process is referred to as stimulated Raman scattering (SRS). In the SRS process, longer wavelength photons stimulate shorter wavelength photons to experience a Raman scattering event. The shorter wavelength photons are destroyed and longer wavelength photons, identical to the longer wavelength photons present initially, are created. The excess energy is conserved as an optical phonon (a lattice vibration). This process results in an increase in the number of longer wavelength photons and is referred to as Raman gain.

The inventive identification technology employs the Raman effect, or inelastic light scattering, a non-invasive method to rapidly acquire the unique chemical signature of any non-metal substance. Every molecule has a different set of vibrational frequencies, and the collection of the spectrum of Raman-shifted light thus provides a characteristic molecular fingerprint. The probability that a Raman scattering even will occur is dependent on the intensity of the light as well as the wavelength separation between the two photons. The interaction between two optical waves due to SRS is governed by the following set of coupled equations:

$$\frac{ⅆ {I}_{s}}{{ⅆ}_{z}} = {g}_{R} {I}_{S} {I}_{p} - {α}_{S} {I}_{S} \frac{ⅆ {l}_{p}}{ⅆ z} = \frac{{λ}_{s}}{{λ}_{p}} {g}_{R} {I}_{S} {I}_{p} - {α}_{p} {I}_{p}$$

where:

Iₛ is the intensity of the signal light (longer wavelength),

Iₚ is the intensity of the pump light (shorter wavelength),

λ_{S} is the signal wavelength,

λₚ is the pump wavelength,

α_{S} and αₚ are the fiber attenuation coefficients at the signal and pump wavelengths, respectively.

The Raman gain coefficient, g_{R}, is dependent on the wavelength difference (λ_{S}λ−λₚ), as is well known in the art.

Two-Dimensional Algorithmic Marks

Two Dimensional Algorithmic Marks (2DAMs) 2DAMs are a totally flexible and unique coding system for the tracking and tracing of products, for example, m at the individual unit level. Further, with the addition of NANO-LOCK's DNA technologies, DNA sequences can be added to the printing inks used to make the NANO-LOCK 2DAM mark. The 2DAM mark could include in its algorithmic form, information about the sequence of DNA for added dimensions of authentication.

These marks can be read from a distance (via high-resolution satellites or fixed camera positions in factory or depot situations) with cameras and standard imagers that are readily available from the market leaders in scanning and imaging technology. The captured image is decoded by dedicated software, which can contain the customer's (private) algorithm. The type of scanner (handheld imager or fixed positioned camera with macro lens) is determined by the size of the mark and the scanning distance. These marks can also be smaller than is visible with the naked eye.

Thanks to its flexible format the 2DMI mark can even be captured by a digital camera and send as a bitmap-file via the Internet to a decoding application or read by the lasers found in DVD players. Off-line recognition is also possible with a combination of imager and PDA. 2DMI marks can be used in many niche applications where other types of 2D codes will not work or in conjunction with other types of codes to expand the information base or the security of the product.

Further details about the 2DMI marks can be found in U.S. Pat. Nos. 6,565,002; 5,719,939; 5,621,219; 5,354,097; and 4,942,831, the disclosures of which are expressly incorporated herein by reference.

Biologic Markers

Biologic markers, such as amino acids and proteins are disclosed in U.S. Pat. No. 5,194,289, cited above. Such biologic materials can be profiled by gas chromatography which creates a standard for later comparison with a small (e.g., nanogram) sample of ink from a stolen object, a counterfeit object, or a diverted genuine object, which objects have been labeled in accordance with the precepts of the present invention. Additionally, U.S. Pat. No. 5,139,812 discloses the use of nucleic acid sequences in ink for identifying an object with a probe. U.S. Pat. No. 4,880,750 discloses the use of individual-specific antibodies (e.g., in an ink) for identification of security documents. U.S. Pat. No. 4,441,943 uses synthetic polypeptides for labeling explosives. British Patent No. 2,209,831 proposes to label objects with a nucleic acid, antibody, or antigen. U.S. Pat. No. 5,451,505 uses nucleic acids as taggants. U.S. Pat. No. 5,429,952 proposes to associate hapten with a product and then later detecting the presence of hapten with a complementary binding member and, thus, identify the product. MHC (major histocompatibility complex is yet another biologic marker suitable for use in the present invention. Thus, the term “biologic marker” should be construed broadly to include biologic materials (natural and synthetic, whole or fragments, naturally occurring, synthetic, and/or modified) for use in accordance with the precepts of the present invention. The disclosures of these citations are expressly incorporate herein by reference.

Such techniques also are not readily perceptible without the aid of special equipment and/or chemicals, which develop the presence of such markers. For present purposes, such markers are unique and not easily (if at all) replicated by the forger or counterfeiter. The foregoing biologic markers may be incorporated into a visible (of the same or a different color from the object or product being marked) or an invisible ink for use in labeling objects. It should be understood also that such biologic markers can be native or can be synthetic, including fragments, single chains, and a variety of additional forms currently developed or yet to be developed. It may even be feasible to radiolabel some biologic or other markers and determine their presence thereby. U.S. Pat. No. 6,030,657 provides more information on biologic markers.

Optical Taggants

An optical marker, which optionally can be attached to a genetic molecule, such as a DNA or other protein strand for further verification, can be used additionally. While both up-converting and down-converting phosphors may be used, particularly useful phosphors are rare earth oxysulfides that fluoresce blue, green, and red at wavelengths of around 475, 545, and 660 nm, respectively, such as selected from those phosphors as described in British patent application 2,258,659, published on Feb. 17, 1993, the disclosure of which is expressly incorporated herein by reference. Such phosphors are described as doped yttrium oxysulphide (Y₂O₂S), in which the dopants comprise, by weight of the oxysulphide, 4% to 50% of one or both of erbium (Er) and ytterbium (Yb). The material may comprise 1 to 50 ppm of one or more other lanthanide elements. Erbium and ytterbium may be replaced by thulium (Tm), holmium (Ho), or lutetium (Lu). The material may be in the form of particles whose average size is no more than 20 μm. Reference also is made to O'Yocom, et al., “Rare-Earth-Doped Oxysulfides for Gallium Arsenide-Pumped Lumines Devices”, Met. Trans., (1971), 2(3), 763-767, and Wittke, et al., “Erbium-Ytterbium Double Doped Yttrium Oxide. New Red-Emitting Infrared-Excited Phosphor”, J. Appl. Phys., (1972), 43(2), 595-600, the disclosures of which are expressly incorporated herein by reference.

With respect to the phosphors as described above (e.g., gallium oxysulfide), such up-converting phosphors require high (peak power) density photon radiation in order to excite emission. A 10 Hz pulsed LED in the 880 nm region of the spectrum with approximately 50 mW peak power should be suitable therefor. With respect to the detector equipment, a simple illuminator can be used where human perception of a greenish glow to determine the presence of the security phosphor is employed.

Another proposed illuminator/detector could be manufactured from a flashing LED with a very narrow pulse width due to the fact that human perception is unnecessary. Such detector could have an optical filter that blocks IR illumination frequency and passes only the frequency of radiation emitted by the phosphor, i.e., target frequency. Such a detector could be used under high ambient light conditions. Such a detector could be configured as a simple swipe-type reader or could have a hinged or removable gate to expose the phosphor to the LED.

A proposed illuminator/detector/reader could have the ability to read encoded patterns of the embedded phosphor, such as, for example, a bar code. The reading capability can be provided by suitable software, such as bar code reader engines.

As an alternative and/or adjunct to phosphors, luminescent labeling based on the lanthenide ions, samarium (III), europium (III), terbium (III), and dysprosium (III), bound by a chelating agent, could be used as labels for DNA, modified DNA, DNA bases, or other biologic markers. Exciting the naphthalene group attached to the chelating agent generates luminescence from such rare earth ions. Thus, light shined on the naphthalene group, which has a long-lived excited state, eventually gives up this excitation energy to the lanthenide ion, which responds by emitting light. Because of the way that the lanthenide ions are linked to naphthalene, a single wavelength of light can excite all four labels, each of them emitting light of a characteristic wavelength. Moreover, the emission bandwidths of the lanthenide ions are narrow, even at room temperature in fluid solution, allowing them to be detected simultaneously with minimum overlap.

Because the lifetimes of the excited states of these ions are relatively long, emission detection can be time-gated, virtually eliminating signals from background sources. Time-gating, for present purposes, comprehends use of a pulsed excitation source which allows a time delay between excitation and detection. Thus, the time delay before detection permits sources of interfering light, such as scattered excitation light, Raman scattering, and impurity fluorescence, to die down before detection is initiated. Another advantage of the lanthenide ions is that they are compatible with both capillary gel electrophoresis, which is considerably faster than conventional sequencing using slab gel electrophoresis, and computer collection and analysis of data. Additionally, measuring rise times, color ratios, etc., add additional advantage to use of the up-converting phosphors.

Ultraviolet radiation (UV) taggants also can be used and are well known in the art. These fluorescent dyes include, for example, various rhodamines, such as Columbia Blue, 8-hydroxy-1,3,6-pyrenetrisulfonic acid trisodium salt (HOPSA, Eastman Chemical Company), Rhodamine B, or Hostacell yellow 8G (American Hoechst Corporation). UV dyes or agents and readers therefor are so well known that little more needs to be said about them here.

Pit & Land Code

The present invention in one aspect is directed to a method for labeling the surface of an object for its identification, which object has a durable or hard surface or a durable surface tag affixed to the object. For present purposes, the term “durable” means a surface whose characteristics are such that it has memory for retaining the label applied thereto. Thus, the surface may be rigid or flexible, so long as the surface retains the label during use of the object and is readable. The inventive method further includes the use of “pit and fall” or “pit and land” (i.e., holes and bumps as are used to record compact discs, CD-ROMs) technology to encode durable surface objects with coded message. The coded message can be information on the owner, a history of the object, or any other information desired. The coded message would not be detectable to the human eye; however, by scanning the pits and falls with a laser, the coded message could be detected and displayed. Such coded message encoding could be used, for example, to label objects for their identification in case of theft, or in case of product counterfeiting or diversion. “Pit and land coded message”, then, for present purposes comprehends data recorded in pit and falls ala CDs wherein the data is unique to the object and not generally known. By not being generally known (except for the manufacturer and those in confidence with the manufacturer), the authenticity/identity of the object can be assured. The object may contain pit and land data useful to the user of the object (e.g., CD, DVD, or the like); however, such pit and land audio and video data does not inform the manufacturer or anyone else of the authenticity/identity of the object. It only is the coded message of the present invention that contains such authentication/identification information (data) and that is within the scope of the present invention.

The pits and falls encoded information desirably is protected by a coating or overcoat the prevent the area encoded with the pits and falls information from becoming inadvertently or deliberately scratched, which would render retrieval of such information difficult, inaccurate, and/or meaningless. While a conventional coating transparent to the wavelength of the laser used to scan the pits and falls can be used, such coating additionally can be part of the security system, e.g., by containing a biologic marker labeled with an agent that emits selected detectable wavelengths of energy when exposed to infrared radiation (IR), and associating the labeled marker with the object, whereby, the object to be identified can be exposed to IR and emitted select wavelengths of energy from said agent detected. The agent can be an upconverting phosphor, a lanthenide ion (bound to a naphthalene group), or other chemical that emits selected detectable wavelengths of energy when exposed to infrared radiation (IR). The coating additionally may contain an agent that is perceptible only in the presence of ultraviolet (UV) radiation, e.g., fingerprint. Combinations of IR and UV agents may be used additionally. While the same laser beam wavelength could be used to read the pits and falls, detect the IR agent, preferably the wavelength for reading the pits and falls will be different than the wavelength used to detect the IR agent; thus, making it more difficult for the copyist to break the code. Additionally, the biologic marker can be encoded to further protect the object being labeled.

Additional information on this pit and land technology can be founding U.S. Pat. No. 6,706,314.

Spectral Analysis

This system uses encapsulated semiconductor quantum dots (QD's) to create an implantable/printable spectral barcode. This barcode utilizes combinations of color and intensity to uniquely code a product. Readout may be accomplished in the field with a portable hand-held spectrometer-based system. It will be appreciated that the encapsulating material can be laced with one or more of a biologic marker, optionally tagged, Ramen scattering material, or algorithmic material, and optionally laid down over a pit & land marked system as part of the overcoat and/or in addition to the pit & and overcoat.

Quantum dots are quasi-zero dimensional semiconductor nano-structures that possess unique optical properties. The diameter of QD's falls below the material's Bohr-exciton radius, which is the characteristic distance between an excited electron and hole within the material. This confines the electron-hole pair in all three dimensions (creating the zero-dimension structure) and causes the structure to possess optical properties that are distinctly different from those of the bulk semiconductor material. Ideally, the continuous density of states of the bulk material is compacted into discrete states that are blue-shifted from the bandgap of the bulk material. Most interestingly, the amount of blueshift is inversely related to the QD diameter with smaller QD's displaying larger blueshifts. In reality, the discrete states are broadened through a number of mechanisms.

Spectral barcoding, then, is similar to spatial barcoding (the ubiquitous barcode scanned at the supermarket checkout) in that it seeks to create coding sequences for automated product differentiation. Instead of using spatial dimensions (i.e., line thickness), spectral barcoding utilizes combinations of colors and intensities to create a unique code. Spectral barcoding, then, requires highly efficient light emitters with a narrow FWHM. The narrow FWHM allows for increased spectral density in the barcode and, therefore, more coding sequences.

While a single QD emits only a single wavelength band, the QD can be embedded in various matrices without a change in its optical properties. For example, plastic microspheres (nominally about 5.5 μm diameter) can house QD's. By mixing the types and amounts of QD's in the host matrix, the user can create a spectral barcode with multiple, m, colors and multiple, n, intensity levels for each color. This results in n^{m}−1 possible combinations.

The spectral barcode of QD's can be interrogated in the field with a simple handheld spectometer/UV source system. The light source could be based on an ultraviolet (UV) lamp or an LED. The fiber optic probe could be coupled with the handheld unit.

The method and type of marking would depend heavily upon the application. QD's encapsulated in plastic (polymeric) microspheres could be put in an “ink” and printed on a label, product container, fabric, and or textiles could be contacted with such an ink to “dye” the threads for incorporation into a garment, for example. Alternatively, the QD's could be dispersed in a material matrix, and that composite painted on or embedded in the product container. Changing the mark would consist merely of altering the QD mixture in the microspheres or in the matrix. It is possible to make the mark as small as about 200 μm in diameter (the size of an optical fiber) or up to around 1 mm in diameter.

The same principles as set forth above enable the system to extended to the near infrared (NIR) spectral region, which extends from about 750 nm to about 2500 nm. PbSe QD's could be made to span the NIR. Again, the same concepts could be extended out past 1100 nm with different illumination and detection materials and systems. The inability of silicon-based detectors to “see” in the NIR could be used to advantage by combining the two systems.

Objects to be Identified

The inventive multi-modal marking system can be used, inter alia, in the analysis and cataloging of artwork and all elements associated with it including any kind of corrosion; identification of anything non-metallic in any form, e.g., solid, liquid, or powder; cellulose and related wood/paper products; foods; pharmaceuticals; general merchandise; collectibles; credit cards; currency and valuable papers.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated. Also, all citations referred herein are expressly incorporated herein by reference.

I claim:

1. A method for labeling an object for one or more of its identification, authentication, or asset management, which comprises the steps of:
(a) creating on said object an algorithmic mark;
(b) associating with said algorithmic mark one or more of Raman spectral material, a biologic taggant, an optical taggant, or a spectral quantum dot (QD) by one or more of:
(1) incorporating in said algorithmic mark one or more of Raman spectral material, a biologic taggant, an optical taggant, or a spectral quantum dot (QD); or
(2) overcoating said algorithmic mark with a transparent coating containing one or more of Raman spectral material, a biologic taggant, an optical taggant, or a spectral quantum dot (QD).

2. The method of claim 1, wherein said biologic taggant is labeled with an optical taggant that one or more of emits selected detectable wavelengths of energy when exposed to infrared radiation (IR) or emits selected detectable wavelengths of energy when exposed to ultraviolet radiation (UV).

3. The method of claim 1, wherein said biologic marker is formed form encoded DNA bases.

4. The method of claim 2, wherein said IR taggant is an up-converting phosphor.

5. A method for labeling an object for one or more of its identification, authentication, or asset management, which comprises the steps of:
(a) creating on said object a pit and land code;
(b) overcoating said pit and land code with a coating containing one or more of Raman spectral material, an optical taggant, or a spectral quantum dot (QD).

6. The method of claim 5, wherein said coating additional contains a biologic taggant.

7. The method of claim 7, wherein said biologic taggant is labeled with an optical taggant that one or more of emits selected detectable wavelengths of energy when exposed to infrared radiation (IR) or emits selected detectable wavelengths of energy when exposed to ultraviolet radiation (UV).

8. The method of claim 6, wherein said biologic taggant is formed form encoded DNA bases.

9. The method of claim 7, wherein said IR agent is an up-converting phosphor.

10. The method of claim 5, further comprising:
(c) creating on said object an algorithmic mark;
(d) associating with said algorithmic mark one or more of Raman spectral material, a biologic taggant, an optical taggant, or a spectral quantum dot (QD) by one or more of:
(1) incorporating in said algorithmic mark one or more of Raman spectral material, a biologic taggant, an optical taggant, or a spectral quantum dot (QD); or
(2) overcoating said algorithmic mark with a transparent coating containing one or more of Raman spectral material, a biologic taggant, an optical taggant, or a spectral quantum dot (QD).

11. The method of claim 10, wherein said biologic taggant is labeled with an optical taggant that one or more of emits selected detectable wavelengths of energy when exposed to infrared radiation (IR) or emits selected detectable wavelengths of energy when exposed to ultraviolet radiation (UV).

12. The method of claim 10, wherein said optical taggant emits selected detectable wavelengths of energy when exposed to one or more of infrared radiation (IR) or ultraviolet radiation (UV).
